(19) United States
(12) Patent Application Publication
(10) Pub. No.: US 2025/0228408 A1
(43) Pub. Date: Jul. 17, 2025

(54) SYSTEM AND METHOD FOR MAKING SMORES-LIKE CONFECTION

(71) Applicant: Andrew Vaccaro, Oradell, NJ (US)

(72) Inventor: Andrew Vaccaro, Oradell, NJ (US)

(21) Appl. No.: 18/413,231

(22) Filed: Jan. 16, 2024

(51) Int. Cl. A47J 43/18; A23G 3/52; A23G 3/54; A23G 3/56

(52) U.S. Cl. CPC A47J 43/18; A23G 3/52; A23G 3/54; A23G 3/56

(57) ABSTRACT

A System and Method is taught for making a S'Mores-like confection. The System is comprised of a stick, a marshmallow, and a specially designed cone. The specially designed cone has a through-hole in its bottom, allowing for it to be mounted on the stick by inserting a first end of the stick through the hole and sliding the specially designed cone towards the second end. A marshmallow is then mounted on the first end. A user can hold the second end of the stick or the specially designed cone while roasting the marshmallow. The System and Method allows a user to enjoy a S'mores-like confection without the drawbacks typically associated with making s'mores.

### FIELD OF INVENTION

This invention relates to the classification for confectionery. It also relates to one or more sub classifications for processes for the preparation thereof. Specifically, this invention is a system in method for making s'mores.

### BACKGROUND OF INVENTION

Though the exact date s'mores were invented is a mystery, the first formal recipe for the treat then called “Some Mores” is recorded in the 1927 book “Tramping and Trailing with Girl Scouts.” The original recipe called for 16 graham crackers, 16 marshmallows and eight bars of chocolate broken in two.

The recipe has remained more or less unvaried ever since. S'mores are made from graham cracker, a chocolate bar, and a fire roasted marshmallow. The user first breaks a graham cracker into two and puts half a chocolate bar on the graham cracker half. Then the user roasts a marshmallow over fire and puts the marshmallow on top and covers it with the other half of the graham cracker, pressing it all together.

Making s'mores is a right of passage for children in the United States. During warm, summer months, families all over the country make s'mores around campfires and fire pits. It is a memory passed down through generations.

But as every parent knows, making s'more's is sticky and messy. The smaller, the child, the messier making s'mores becomes. Additionally, parents have to keep a close eye on their children during this s'mores making process, to ensure that the child is not burnt and does not create a mess.

Due to the limitations inherent in making s'mores, most families tend to only make them once or twice a summer. The market desires a system and method for making s'mores, or a treat similar to a s'mores, that has none of the draw back but all of the taste and sentimentality.

### SUMMARY OF THE INVENTION

This summary is intended to disclose the present invention, a System and Method for Making a S'mores-like Confection. The embodiments and descriptions are used to illustrate the invention and its utility, and are not intended to limit the invention or its use. In the illustrated embodiment, the System and Method for Making a S'mores-like Confection is shown in conjunction with a fire.

The system for making a s'mores-like confection is comprised of a stick, a marshmallow, a specially designed cone, and a fire. The specially designed cone has a hole in the bottom center through which the stick fits. The cone turns into a holder for the stick assembly. In one embodiment, the cone, itself, is made from graham cracker material, shaped and formed much like a traditional ice cream cone. In another embodiment, the cone is made from traditional cake ice cream cone confection. In another embodiment, the inside of the cone is layered with a layering confection. The layering confection can be one or more of milk chocolate, white chocolate, dark chocolate, fondant, and pastel. In another embodiment, the outside of the cone is layered with a layering confection. When the outside of the specially designed cone is layered with a layering confection, it can be treated with one or more of sprinkles, crystal sugar, and nonpareils. Whether used as an inside or outside layering, the layering confection can have additional flavorings such as mint, caramel, cinnamon, pumpkin spice, almond, orange, and cherry. The layering confection can also have embedded material such as toffee, caramel, coconut, nuts, and fruits. In yet another embodiment, both the inside and outside of the cone are layered with layering confection.

The method for making a s'mores-like confection is comprised of creating a specially designed cone with a through-hole in its bottom center; inserting a first end of a stick through a specially designed cone; sliding the cone along the stick until its bottom is in proximity with the second end of the stick; placing a marshmallow on the first end of the stick; extending the marshmallow over a fire; roasting the marshmallow over the fire; removing the marshmallow from the fire; sliding the cone up the stick toward the first end of the stick; capturing the marshmallow with the inside of the cone; continuing with the sliding motion until the cone and captured marshmallow come off the first end of the stick upon which the marshmallow was roasted; and consuming the confection made therefrom.

Additional steps can be added to the method, such as using the cone as a holder while the marshmallow is being roasted so that the fire roasts the marshmallow; making a through-hole in the marshmallow; sharpening the first end of the stick; coating the inside of the cone with a layering confection; coating the outside of the cone with a layering confection; coating both the inside and outside of the cone with a layering confection; fabricating the cone from graham cracker material; fabricating the cone from traditional cake ice cream cone material; and fabricating the cone from a waffle-like material.

It is, of course, totally arbitrary which end of the stick is the first end and which end of the stick is the second end.

It should also be noted that the invention contemplates placing the first end of the stick through the specially designed cone and sliding the cone until the bottom of the cone is in proximity to the second end. This is done because it is much easier to place the stick through the hole in the cone from the outside of the cone. Trying to insert the stick into the cone from the inside of the cone causes undue damage to the cone, although it is possible to do that.

### BRIEF DESCRIPTION OF THE DRAWINGS

The present invention is illustrated with 9 figures on 10 sheets.

FIG. 1 is a perspective view of a stick, a marshmallow, and a specially designed cone. FIG. 2 is a perspective view of the stick placed through a through-hole in the bottom of the specially designed cone, with the bottom of the specially designed cone in proximity to a second end of the stick.

FIG. 3A is a perspective view of the marshmallow being mounted on the first end of the stick and the cone being mounted on the second end of the stick. FIG. 3B is a perspective view of the marshmallow being mounted on the first end of an alternative embodiment of the stick and the cone being mounted near a positioning disc.

FIG. 4 is a top perspective view of the marshmallow being roasted over a fire.

FIG. 5 is perspective view of the cone being slid from the second end of the stick to the first end of the stick. FIG. 6 is a perspective view of the cone capturing the marshmallow near the first end of the stick. FIG. 7 shows the captured marshmallow and cone having been removed from the stick.

FIG. 8A shows an unadorned modified cone. FIG. 8B is a cut-away showing the inside of the modified cone being layered with a layering confection. FIG. 8C is a cut-away showing the inside and outside being layered in a layering confection. FIG. 8D is a bottom view of the specially designed cone with a through-hole in its bottom.

FIG. 9 is a perspective view of a second embodiment of the modified cone, in which the upper part of the cone has been elongated and widened to more easily accommodate a marshmallow.

FIG. 10 is a side view of a marshmallow.

### DETAILED DESCRIPTION OF THE DRAWINGS

The following descriptions are not meant to limit the invention, but rather to add to the summary of invention, and illustrate the present invention, by offering and illustrating various embodiments of the present invention, a System and Method for Making a S'mores-like Confection. While embodiments of the invention are illustrated and described, the embodiments herein do not represent all possible forms of the invention. Rather, the descriptions, illustrations, and embodiments are intended to teach and inform one skilled in the art without limiting the scope of the invention.

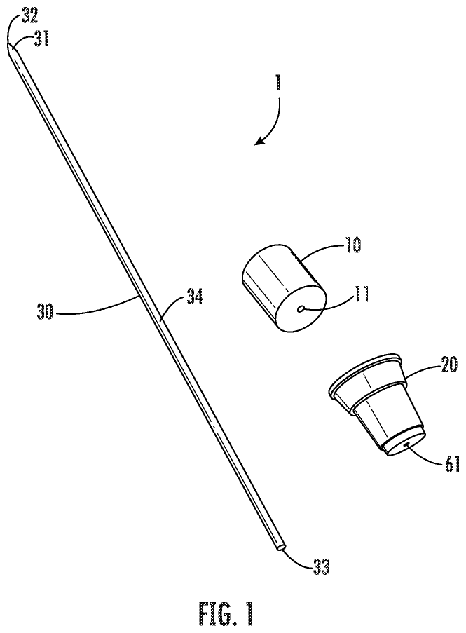

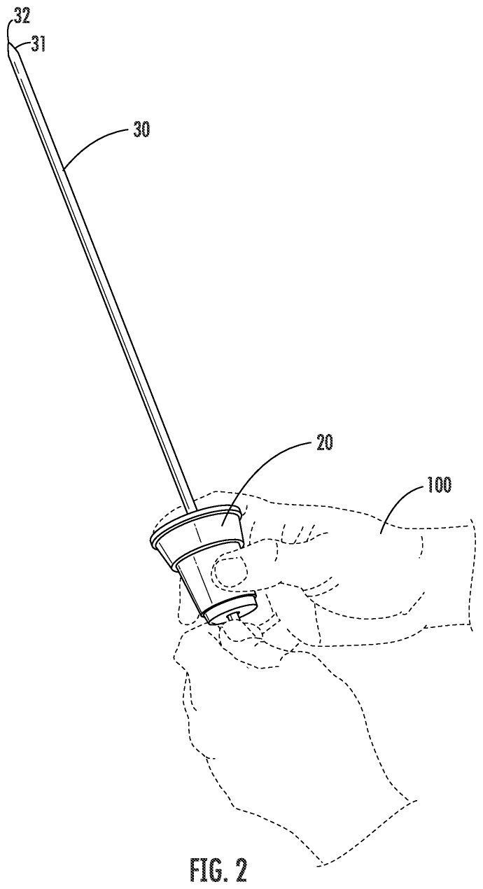

Referring to FIG. 1, the System for Making a S'mores-like Confection 1 is comprised of a marshmallow 10, a specially designed cone 20, and a stick 30. The stick 30 has a first end 32 and a second end 33. In one embodiment, the first end 32 is pointed 31. The stick has a continuous cylindrical surface 34 between the first end 32 and the second end 33. The specially designed cone 20 has a through-hole 61 in the center of its bottom. Likewise, the marshmallow 10 has a through-hole 11.

FIG. 2 shows a user 100 mounting the specially designed cone 20 on the stick 30. This is done by inserting the pointed end 31 of the first end 32 through the through-hole 61 in the specially designed cone 20 and sliding the specially designed cone 20 until it is proximity of the second end 33 of the stick 10.

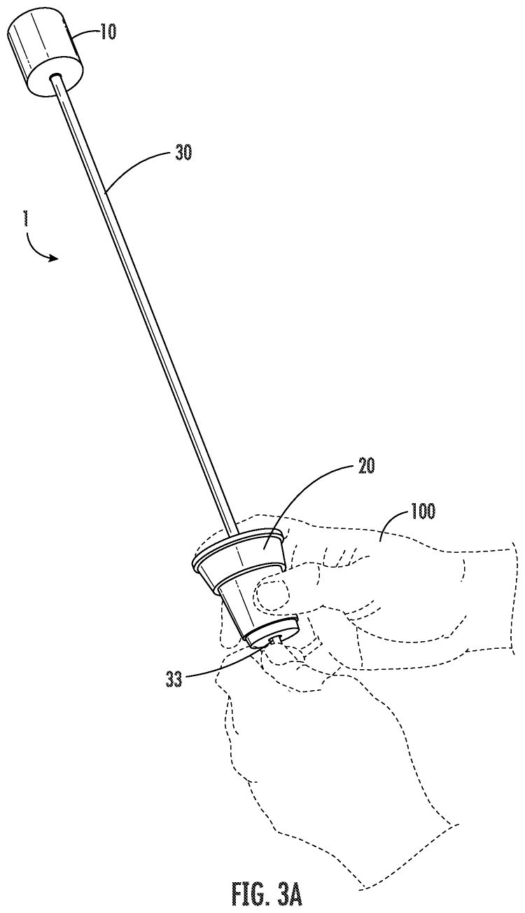

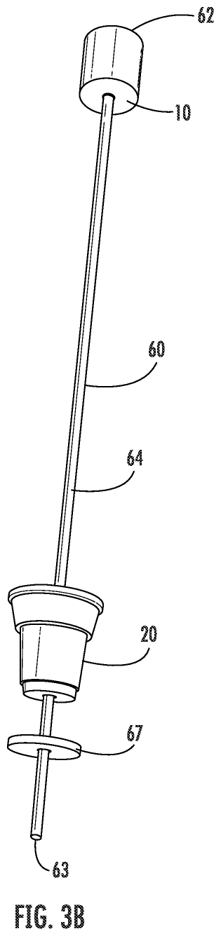

FIG. 3A shows the present invention 1 with the marshmallow 10 now mounted on the first end 32 of the stick 10. FIG. 3B shows an alternative embodiment of the stick 60 in which there is a positioning disc 67 secured to the continuous cylindrical surface 64 of the stick 60, in proximity of its second end 63. The positioning disc 67 prevents the specially designed cone 20 from sliding off the second end 63 of the stick 60. The marshmallow 10 is mounted on the first end 62.

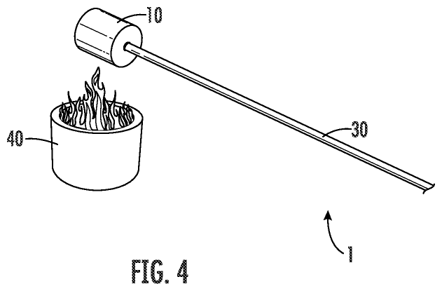

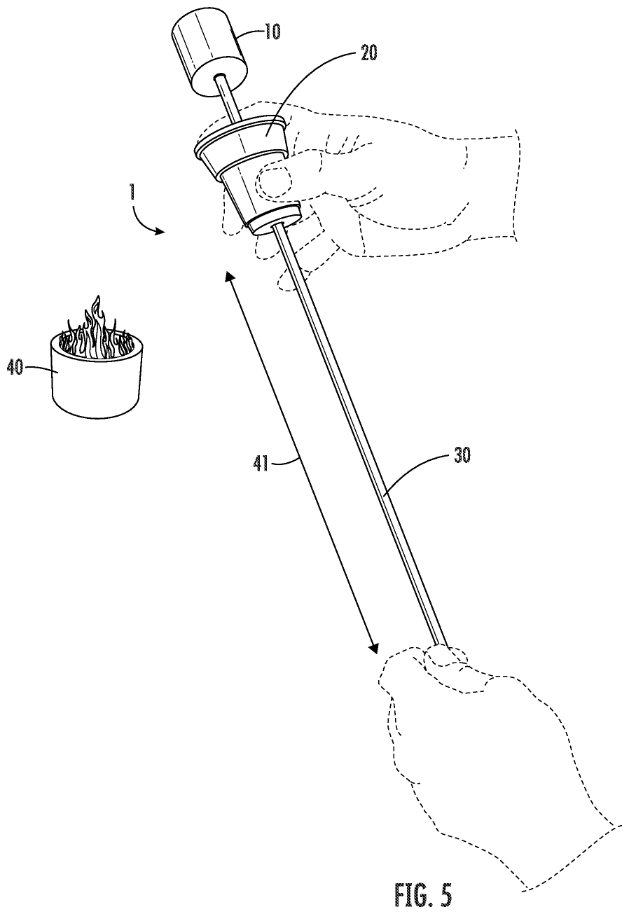

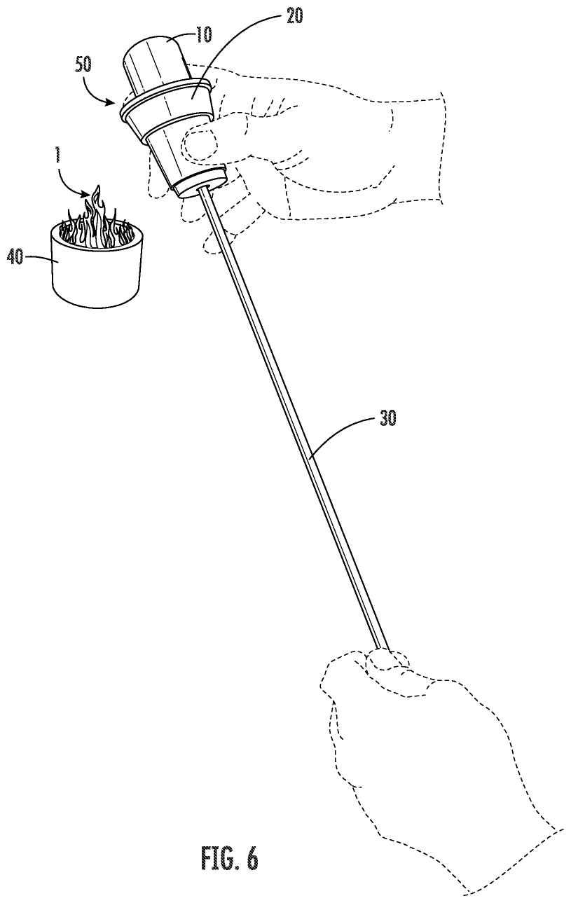

FIG. 4 shows the present invention 1 being used to roast the marshmallow 10 over an open fire 40 while the marshmallow is secured to the stick 30. As shown in FIG. 5, once the marshmallow 10 is suitably roasted, it is removed from the open fire 40, The user 100 then slides 41 the specially designed cone 20 towards the first end 32 of the stick 30. FIG. 6 shows the specially designed cone 20 capturing the marshmallow 10 after it has been slid 41 up the stick 30. This creates the confection 50, which is comprised of a roasted marshmallow 10 embedded in a specially designed cone 20 that is layered in a layering confection. FIG. 7 shows the user 100 holding the confection 50 comprised of the marshmallow 10 and specially designed cone 20. The through-hole 61 in the bottom of the specially designed cone 20 is apparent in this view.

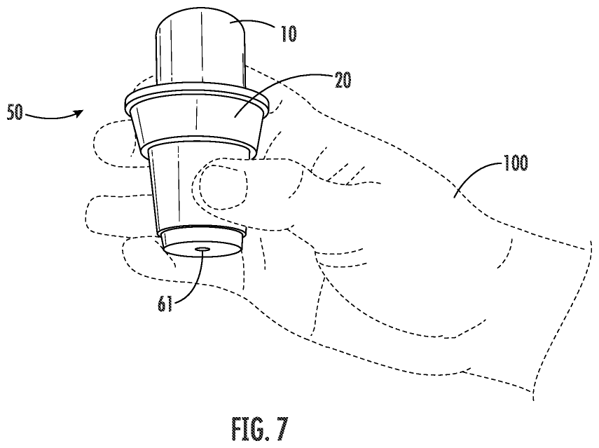

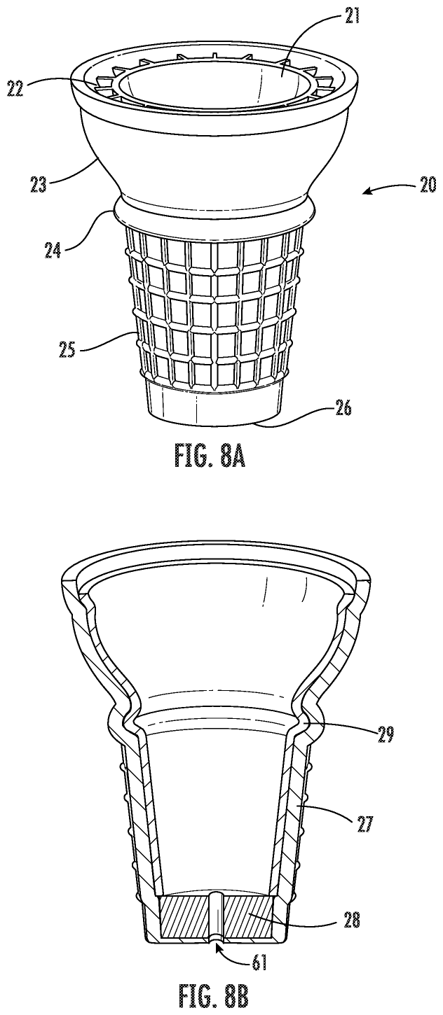

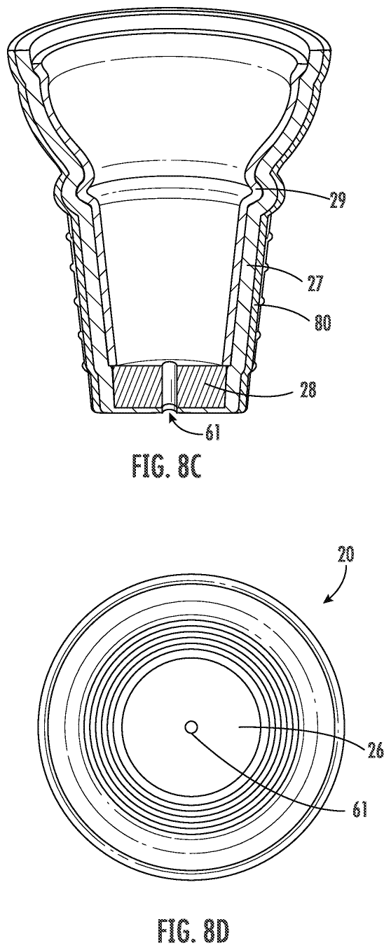

FIG. 8D shows the bottom 26 of the specially designed cone 20 with a through-hole 61 in its bottom 26. The through-hole 61 is sized to accommodate the stick 30. FIG. 8A shows the specially designed cone 20. It has an inner vessel 21, a rim 22, an upper outer surface 23, a collar 24, a waffled lower cylindrical surface 25, and a bottom. FIG. 8B shows a cross-section of the specially designed cone 20 showing the cone material 27. The specially designed cone 20 in this embodiment is layered on the inside with layering confection 29 with a layering confection disc 28 in the bottom 26. In this embodiment, the through-hole 61 extends through both the cone bottom 26 and the layering confection disc 28. FIG. 8C shows an alternative embodiment in which the specially designed cone 20 is layered inside 27 and out 70 with one or more layering confections. In this embodiment, the disc of layering confection 28 is still in the bottom of the cone, and the through-hole 61 still extends through the layering confection disc.

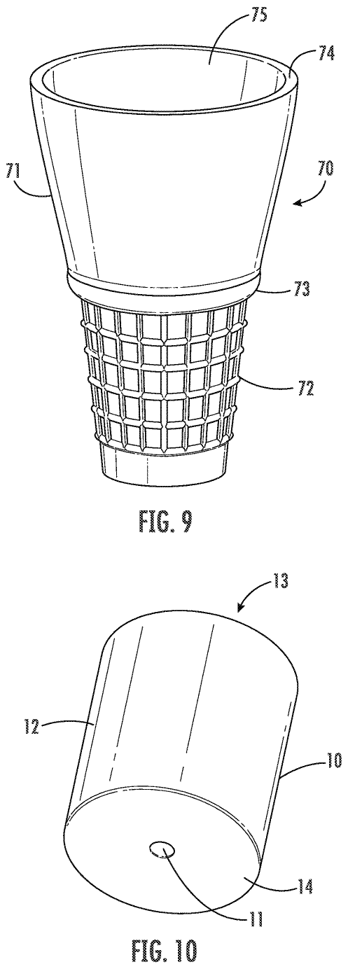

FIG. 9 shows an alternative embodiment of the specially designed cone 70, in which the vessel 75 has been enlarged as has the upper outer surface 71. This modification allows the marshmallow 10 to fit totally within the vessel 75 portion of the specially designed cone 70. This embodiment of the specially designed cone 70 has a rim 74, a collar 73, and a waffled lower cylindrical surface 72. This specially designed cone 70 can be layered inside 27 and out 80 with layering confection. When layered inside 27 with layering confection a bottom disc of layering 28 naturally forms, requiring that the through-hole 61 be extended through the layering confection disc 28.

FIG. 10 shows a marshmallow 10, with a top surface 13, a cylindrical side surface 12, and a bottom surface 14. A through hole 11 can optionally be added.

The system is comprised of a stick 30, 60, a marshmallow 10, and a specially designed cone 20, 70. The stick 30, 60 has a first end 32, 62 and a second end 33, 63. In an alternative embodiment, the stick has a point 31 on the first end 32. In another alternative embodiment, the stick has a positioning disc 67 in proximity to its second end. The specially designed cone 20, 70 has a through-hole 61 in its bottom 26. In an alternative embodiment, the specially designed cone 20, 70 is layered inside 27 with a layering confection. This results in a layering confection disc 28 in the bottom of the cone. The through-hole 61 extends through the layering confection disc. In an alternative embodiment, the specially designed cone is layered outside 80 with layering confection. In another alternative embodiment, the specially designed cone is layered inside 27 and outside 80 with layering confection. The layering confection 27, 80 can be one or more of milk chocolate, white chocolate, dark chocolate, fondant, and pastel. When layering confection 80 coats the outside of the specially designed cone 20, the layering confection 80 can be treated with one or more of sprinkles, crystal sugar, and nonpareils. Whether used as an inside or outside layering 27, 80, the layering confection 27, 80 can have additional flavorings such as mint, caramel, almond, cinnamon, pumpkin spice, orange, and cherry. The layering confection 27, 80 can also have embedded material such as toffee, caramel, coconut, nuts, and fruits.

The method is comprised of the following steps: placing a specially designed cone 20, 70 on a stick 30, 60 by inserting a first end 32, 62 of the stick 30, 60 into a hole 61 in the bottom 26 of the specially designed cone 20, 70; sliding the specially designed cone 20, 70 down the stick 30, 60 until its in near proximity to the second end 33, 63 of the stick 30, 60; placing a marshmallow 10 on the first end 32, 62 of the stick 30, 60; roasting the marshmallow 10 over an open fire 40 while the user 100 holds the second end 33, 63 of the stick 30, 60; removing the marshmallow 10 from the fire 40 when it has achieved a consistency and coloring desired by a user 100; sliding 41 the specially designed cone 20, 70 up the stick 30, 60 towards the first end 32, 62; capturing the marshmallow 10 in the vessel 21, 75 of the specially designed cone 20, 70; and removing the confection 50 so created from the stick 30, 60. The second end 33, 63 stick 30, 60 can be held while roasting the marshmallow 10. Alternatively, a user 100 can hold the specially designed cone 20, 70, while roasting the marshmallow 10.

The System and Method of this application allow for a child to make a Smores-like confection 50 without the typical sticky mess associated with making a s'more. The System and Method is also safer for a child in that the child never touches the marshmallow 10 once it is roasted. Rather, the child or other user would use the specially designed cone 20, 70 to capture the marshmallow 10. The System and Method allows a user to enjoy a S'mores-like confection 50 without the drawbacks typically associated with making s'mores.

We claim:

1. A System for Making a S'mores-like Confection comprising
a stick having a first end, a second end, and a continuous cylindrical surface;
a marshmallow;
a specially designed cone having an inner vessel, a rim, an upper outer surface, an outer transition surface, a waffled lower cylindrical surface, and a bottom;
wherein the bottom of the specially designed cone has a through-hole in the center which is sized to accommodate the stick;
wherein the specially designed cone can be mounted on the stick by inserting the first end of the stick into the through-hole and sliding the specially designed cone down the stick until it is in proximity to the second end of the stick; and
wherein the marshmallow can be mounted on the first end of the stick.

2. The System for Making a S'mores-like Confection in claim 1, wherein the marshmallow can be roasted over an open flame by a user until such time as the user decides that the marshmallow is sufficiently roasted.

3. The System for Making a S'mores-like Confection in claim 2, wherein the specially designed cone can be slid from the being in proximity of the second end of the stick towards the first end of the stick, until such time as the marshmallow is captured in the inner vessel.

4. The System for Making a S'mores-like Confection in claim 3, wherein the inner vessel of the specially designed cone is sized so as to fully accommodate the marshmallow.

5. The System for Making a S'mores-like Confection in claim 3, wherein the stick is further comprised of a positioning disc affixed in proximity to the second end of the stick.

6. The System for Making a S'mores-like Confection in claim 3, wherein the specially designed cone is layered inside with a layering confection.

7. The System for Making a S'mores-like Confection in claim 6, wherein the layering confection is at least one of milk chocolate, white chocolate, dark chocolate, fondant, and pastel.

8. The System for Making a S'mores-like Confection in claim 7, wherein the specially designed cone is layered outside with a layering confection.

9. The System for Making a S'mores-like Confection in claim 3, wherein the specially designed cone is layered outside with a layering confection.

10. The System for Making a S'mores-like Confection in claim 8 or 9, wherein at least one of sprinkles, crystal sugar, and nonpareils coat at least part of the layering confection.

11. The System for Making a S'mores-like Confection in claim 7, 8, 9, or 10 wherein the layering confection is flavored with at least one of mint, caramel, almond, cinnamon, pumpkin spice, orange, and cherry.

12. The System for Making a S'mores-like Confection in claim 7, 8, 9, 10, or 11 wherein the layering confection is embedded with at least one of toffee, caramel, coconut, nuts, and fruits.

13. A Method for Making a S'Mores-like Confection comprising the steps of
placing a specially designed cone on a stick by inserting a first end of the stick into a hole in the bottom of the specially designed cone;
sliding the specially designed cone down the stick until its in near proximity to the second end of the stick;
placing a marshmallow on the first end of the stick;
roasting the marshmallow over an open fire while a user holds the second end of the stick;
removing the marshmallow from the fire when it has achieved a consistency and coloring desired by a user;
sliding the specially designed cone up the stick towards the first end;
capturing the marshmallow in an inner vessel of the specially designed cone; and
removing the confection so created from the stick.

14. The Method for Making a S'Mores-like Confection of claim 13 further comprising the step of holding the second end of the stick while roasting the marshmallow.

15. The Method for Making a S'Mores-like Confection of claim 13 further comprising the step of holding the specially designed cone while roasting the marshmallow.

16. The Method for Making a S'Mores-like Confection of claim 13, wherein the specially cone is layered inside with a layering confection, and wherein the layering confection is at least one of milk chocolate, white chocolate, dark chocolate, fondant, and paste.

17. The Method for Making a S'Mores-like Confection of claim 13, wherein the stick has a positioning disc affixed in proximity to the second end of the stick.

18. The Method of Making a S'Mores-like Confection of claim 17, wherein the user slides the specially designed cone down the stick until contacts the positioning disc.
